(19) United States
(12) Patent Application Publication
(10) Pub. No.: US 2007/0100986 A1
(43) Pub. Date: May 3, 2007

(54) Methods for improving interactive online collaboration using user-defined sensory notification or user-defined wake-ups

(76) Inventors: Elizabeth V. Bagley, Cedar Park, TX (US); Pamela Ann Nesbitt, Tampa, FL (US); Amy Delphine Travis, Arlington, MA (US); Lorin Evan Ullmann, Austin, TX (US)

Correspondence Address: IBM CORP (YA);C/O YEE & ASSOCIATES PC, P.O. BOX 802333, DALLAS, TX, 75380, US

(21) Appl. No.: 11/260,561

(22) Filed: Oct. 27, 2005

(51) Int. Cl. G06F 15/173

(52) U.S. Cl. 709/224

(57) ABSTRACT

A method, system, and computer program product for improving interactive online collaboration using user-defined sensory notification or user-defined wakeups in online collaborative operating environments. The mechanism of the present invention employs user-defined wakeup signals, including sensory notification alerts, to alert the meeting participant when a specific event occurs or specific material has been presented in the online meeting. A user defines an event in the collaborative environment. The mechanism of the present invention monitors the collaborative environment to detect the occurrence of the user-defined event. Upon detecting the occurrence of the user-defined event, the mechanism of the present invention sends a sensory notification to the user to alert the user that the user-defined event has occurred and re-direct the user's attention to the online collaboration.

### BACKGROUND OF THE INVENTION

1. Field of the Invention

The present invention relates generally to an improved data processing system, and in particular, to a method for improving interactive online collaboration using user-defined sensory notification or user-defined wakeups in online collaborative operating environments.

2. Description of the Related Art

Widespread use of computers and the interconnectivity provided through networks allows for different users to collaborate or work with each other in different locations. Collaborating users may be as close as in an office down the hall or on another floor, or as far away as in another city or country. Regardless of the distance, users are able to communicate with each other and collaborate on different projects. For instance, users can communicate with each other through email and instant messages over networks, such as wide-area networks and the Internet. In addition to email and instant messaging, users may use online collaboration tools to conduct presentations and e-meetings, wherein participants may converse with each other in real-time.

A problem with online collaborative operating environments is that a participant may often lose interest, stop listening, and start doing something else during e-meetings because there is no face-to-face contact between the participant and others attending the e-meeting. In contrast, participants in face-to-face meeting environments are typically more attentive than online conferencing participants, since a participant's inattentiveness in a face-to-face meeting may be easily noticed by others. Thus, while inattentive participants in a face-to-face environment may appear rude or suffer repercussions for their actions, there are fewer pressures of this kind in an online collaborative environment.

There are some features in existing systems that encourage interaction between participants meeting in an online collaboration environment, such as document sharing, chat sessions, screen sharing, and polling mechanisms. Common interactive methods include polling mechanisms which generally provide a user-input form and a consensus results display. The user-input form may be a combination of a question and a series of options in the form of selectable buttons associated with a descriptive text, wherein a user may select and possibly confirm a choice or preference. Other mechanisms for maintaining participant interaction employ instant messaging for communicating with the presenter or other participants in the conference, as well as providing pre-defined drop-down lists of possible messages a participant may send to others, such as, for example, “I have a question” or “I am fine”. Selectable icons are also used to encourage interaction by allowing participants to send specific messages, such as a raised hand icon to indicate that the participant has a question, smiley face and clapping hands icons to indicate the participant's laughter or applause, or an open doorway icon that indicates that the user has stepped out of the conference. However, none of these existing interactive methods allow participants to define custom sensory notifications or “wake-ups” to alert a participant to pre-defined events in the conference, such that the notification re-directs the participant back the conference.

Therefore, it would be advantageous to have a mechanism for improving interactive online collaboration using user-defined sensory notification or user-defined wakeups in online collaborative operating environments.

### SUMMARY OF THE INVENTION

Embodiments of the present invention provide a method, system, and computer program product for improving interactive online collaboration using user-defined sensory notification or user-defined wakeups in online collaborative operating environments. The mechanism of the present invention employs user-defined wakeup signals, including sensory notification alerts, to alert the meeting participant when a specific event occurs or specific material has been presented in the online meeting. A user defines an event in the collaborative environment. The mechanism of the present invention monitors the collaborative environment to detect the occurrence of the user-defined event. Upon detecting the occurrence of the user-defined event, the mechanism of the present invention sends a sensory notification to the user to alert the user that the user-defined event has occurred and re-direct the user's attention to the online collaboration.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a representation of a network of data processing systems in which the present invention may be implemented;

FIG. 2 is a block diagram of a data processing system in accordance with illustrative embodiments of the present invention;

FIG. 3 is an exemplary block diagram illustrating the relationship of software components operating within a computer system in accordance with an illustrative embodiment of the present invention;

FIG. 4 is an exemplary block diagram of a user-defined sensory notification system in accordance with an illustrative embodiment of the present invention;

FIGS. 5A-C are example graphical user interfaces illustrating how a user may select and define events in the collaboration in accordance with an illustrative embodiment of the present invention; and

FIG. 6 is a flowchart of a process for improving interactive online collaboration using user-defined sensory notification or user-defined wakeups in accordance with an illustrative embodiment of the present invention.

### DETAILED DESCRIPTION OF THE PREFERRED EMBODIMENT

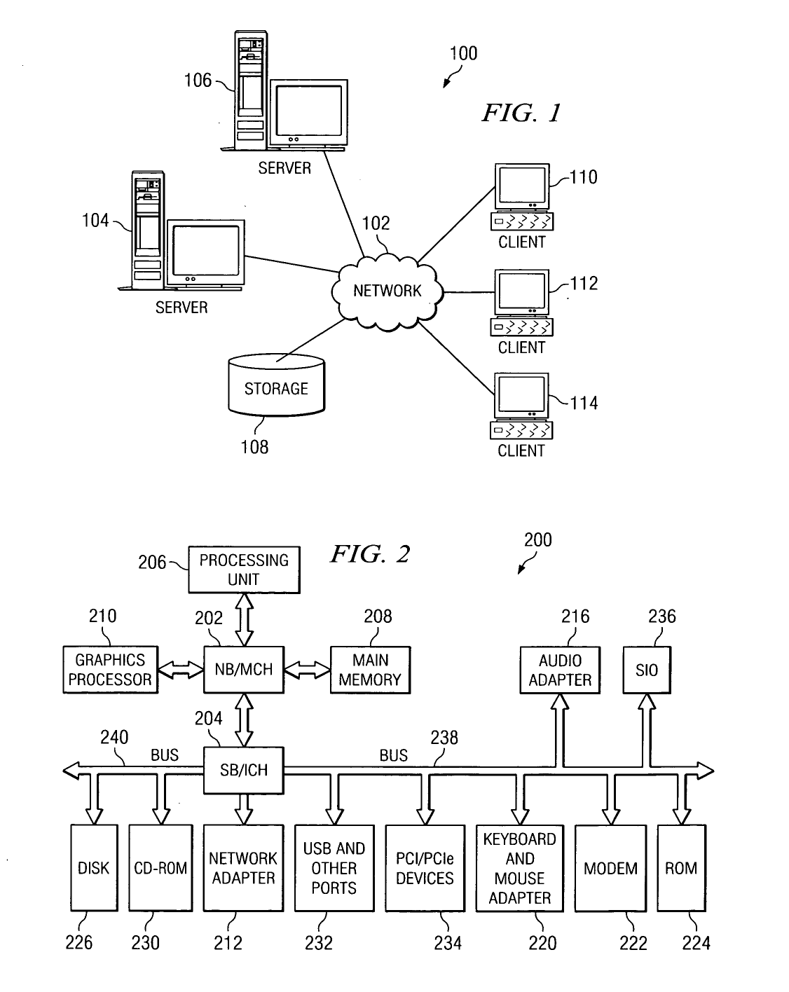

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a method for alerting or waking a participant in an online conference or e-meeting. When a user “attends” an online meeting, it can be common for the user to lose interest in the content of the meeting, especially when only a portion of the meeting pertains to the user. The mechanism of the present invention addresses this problem by re-directing the user's attention back to the meeting in response to the occurrence of a user-defined event. The mechanism of the present invention employs wakeup signals, including sensory notification alerts, to alert the meeting participant when a specific event occurs or specific material has been presented in the online meeting. In particular, the aspects of the present invention provide alert formats to engage human senses, including touch and smell.

In contrast with conventional systems that merely allow users to select, from a list of predefined events, the events upon which the users want to be notified, the mechanism of the present invention allows participants in an online collaboration to define the events upon which they want to be notified. A user may create a collaboration event such as, for example, when a certain phrase is spoken or a particular slide is shown in a presentation. If the event occurs, the mechanism of the present invention alerts the user as to the occurrence of the user-defined event. Thus, the users themselves are allowed to create specific collaboration events upon which to be notified. Other examples of possible events that participants may create in collaboration environments include, but are not limited to, the starting of a quiz, a first question is asked, silence on the call, when a participant having a particular zip code joins the collaboration (e.g., sales territory), use of certain real estate on the screen, the beginning of a break, a change in price in a pay per question or pay per slide scenario, or when the average weight or age of the participants reach a maximum or minimum.

User-defined wakeup signals allow each participant to select the particular notification that will be used to alert the participant. The participant may also define the specific event that triggers the alert and re-directs the participant's attention to the meeting. A wakeup signal may be sent to the participant when the specific event has occurred in the meeting. Thus, although a participant may lose focus on the meeting and may be performing other activities, the participant may still be re-directed to the meeting at pre-determined points in the meeting using sensory notification alerts.

The mechanism of the present invention may identify the occurrence of user-defined events by parsing the audio and video feeds of the online meeting. The parsed audio and video feeds may be analyzed to determine when the specified material has occurred, or when a keyword has been spoken. In addition, the mechanism of the present invention may also monitor participant actions, such as the arrival and departure of participants, and general actions, such as silence on the call, to identify the occurrence of user-defined events. For instance, if a user wants to be notified when the user's manager joins the meeting, the mechanism of the present invention may track participant actions in the meeting. When the user's manager logs into the collaboration, the mechanism of the present invention detects the arrival of the user's manager and notifies the user of the event.

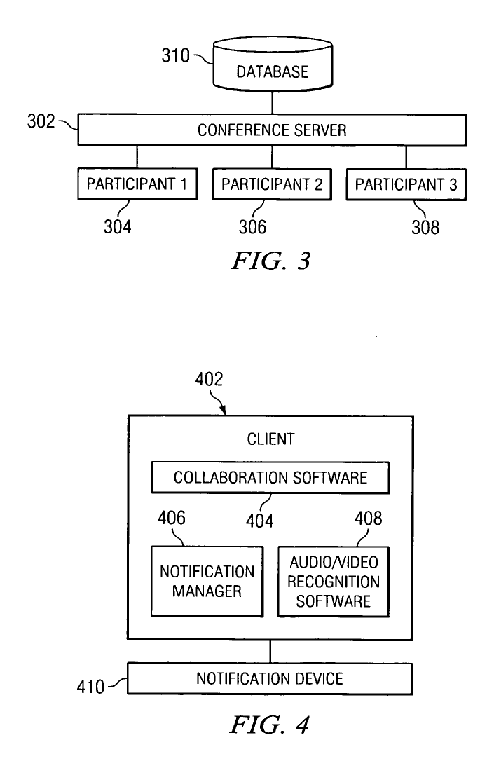

With reference now to FIG. 3, an exemplary block diagram illustrating how an online meeting may be hosted on a conference server according to an illustrative embodiment of the present invention is shown. Conference server 302 may permit one or more clients to log in to a meeting. Conference server 302 may support packet distribution of voice and video from one or more clients over network connections with each client. Conference server 302 may be implemented in a server such as server 104 or 106 in FIG. 1.

In this illustrative example, three participants are shown to have joined the meeting through client applications 304-308. Each client application may be applications operating on distinct computers, such as, for example, clients 110-114 in FIG. 1. One of the client applications may be co-resident on conference server 302, such that that conference server may operate a conference host application and a conference client application.

Conference server 302 may access database 310. Database 310 may store information concerning participants, which may be looked up with reference to a login identifier of each participant. Database 310 may be implemented in, for example, storage unit 108 in FIG. 1.

FIG. 4 is an exemplary block diagram of a notification system in a data processing system in accordance with an illustrative embodiment of the present invention. The notification system may be implemented in a client computer, such as client devices 110-114 in FIG. 1.

In this-illustrative example, client computer 402 comprises collaboration software 404, notification manager 406, and audio/video recognition software 408. Collaboration software 404 allows a participant to login to the online meeting hosted by a conference server, such as conference server 302 in FIG. 3. Audio and video of the meeting is then provided to client computer 402, which is displayed using collaboration software 404.

A participant may define a wakeup signal to be used to alert the participant that a user-defined event has occurred in the meeting. Notification manager 406 is used to receive information from the participant as to what specific event does the user want to be alerted, and which particular sensory notification should be used to notify the user that the event has occurred. The participant may define meeting events and their associated sensory alerts prior to the commencement of the meeting, or while the meeting is taking place.

During the meeting, audio/video recognition software 408 receives an audio and video feed from the meeting. Audio/video recognition software 408 parses the audio and video feeds and converts them into electronic text. Notification manager 406 analyzes the electronic text to determine whether an event defined by the participant has occurred in the meeting. For example, if the participant wants to be notified when the speaker mentions “Project X”, notification manager 406 may perform a keyword search on the electronic text of the audio feed to determine if the phrase “Project X” has been spoken. Likewise, if the participant wants to be notified when there is a break in the meeting, notification manager 406 may perform a keyword search on the electronic text of the audio feed to determine if the term “break” has been spoken. The keyword searches performed by the notification manager are not limited to a single word or phrase, but also allow for any combination of words in any order spoken within a defined time period. In another example, audio/video recognition software 408 may also parse the video feed of the meeting to determine the current slide shown in the presentation. If the participant wants to be alerted when the slide number thirty-five is displayed in the meeting, notification manager 406 analyzes the electronic text of the video feed to determine the current slide shown, and alerts the participant when the desired slide is displayed.

Notification device 410 is connected to client computer 402 and provides the notification alert to the participant. Depending upon the implementation, notification device 410 may reside within client computer 402, or alternatively, an external device connected to the client computer, as shown. In addition, although one notification device is shown, one or more notification devices may be used to implement aspects of the present invention. When notification manager 406 determines that an event defined by the participant has occurred in the meeting, notification manager 406 determines the type of notification alert to be sent to the participant based on the defined event. In other words, when the participant initially defines the event, the participant may also define the type of alert with which the participant wants to be notified. For example, if the user wants to be notified when “Project X” is mentioned, the user may define that event and associate a sensory notification type with the event.

Based on the notification type associated with the defined event, notification manager 406 instructs the appropriate notification device able to provide the associated notification to the participant to alert the participant to the occurrence of the event. Notification device 410 is used to provide at least one of these sensory notifications to the participant. These sensory notifications may include an audio alert, such as emitting particular sounds to gain the participant's attention, or a visual alert, such as changing the appearance of the display, or a combination of both. In addition, notification device 410 may also alert a user through the user's olfactory senses. The notification device may emit a scent, such as a coffee or citrus scent, that may grab the user's attention that the event has occurred. Scents used to alert users may include scents that have been shown to increase alertness. As people from different cultures may react to smells differently, the notification device may be configured to emit a variety of scents, the particular scent used for the alert to be defined by the participant. The notification device may also use a tactile alert to notify the user. For example, if the notification device is a keyboard or mouse, the keyboard or mouse may become hot or cold, such that the user feels the change in temperature of the keyboard or mouse and is notified of the occurrence of the event. These sensory notifications may be used alone or in combination with each other to re-direct the participant's attention to the meeting.

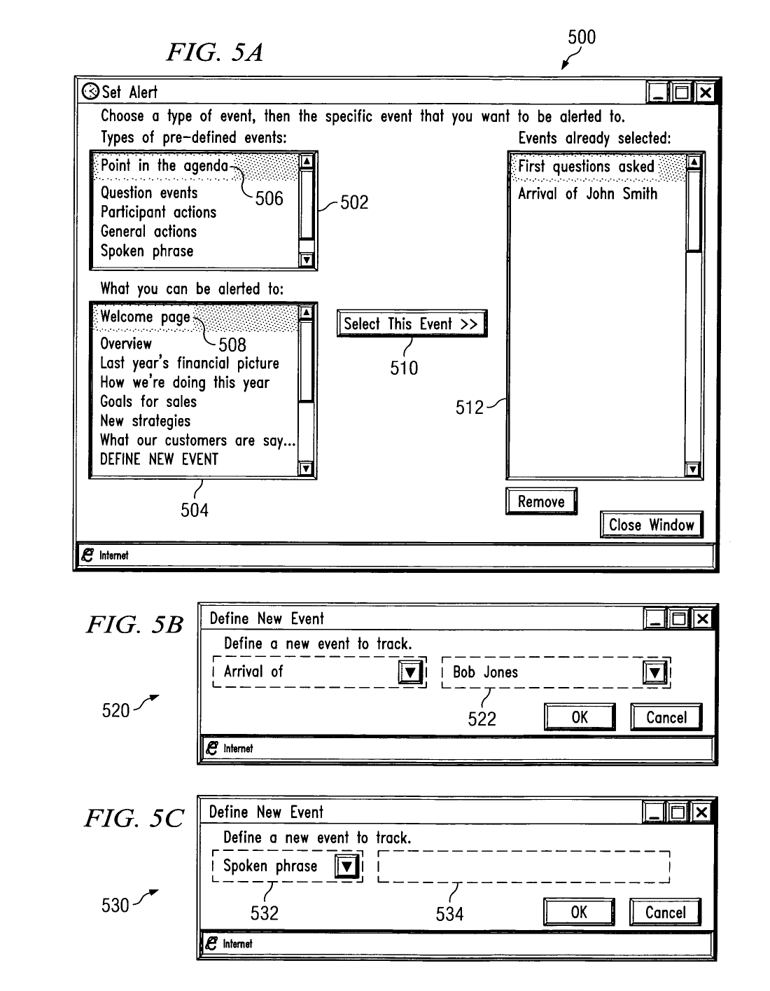

FIGS. 5A-C are example graphical user interfaces illustrating how a user may define events in the collaboration in accordance with an illustrative embodiment of the present invention. In particular, FIG. 5A shows a window that may be presented to the user when the user wants to set a notification alert. Set Alert window 500 provides users with the ability to select predefined events as well as define new events upon which the user wants to be notified. In this illustrative example, set alert window 500 is shown to comprise a list of pre-defined event types 502. Pre-defined Event Type list 502 contain a selectable list of event types contained in the collaboration. As shown, pre-defined Event Type list 502 may comprise event types such as, for example, “point in the agenda”, “question events”, “participant actions”, “general actions”, “spoken phrase”, and the like.

When a user selects one of the event types in Event Type list 502, Event list 504 is updated to reflect the event type selected. For example, if the user selects Point in the Agenda 506 type as shown, Event list 504 may contain selectable event associated with Point in the Agenda, such as the Welcome Page, Overview, Last Year's Financial Picture, Quiz/Test. Example events that may be associated with the other event types listed in Event Type list 502 include “first question” for type Question Events, “arrival of [name, participant number, and/or relative importance of arriving participant weighted on an average threshold set]”, “departure of [name of departing participant]”, and “question asked by [name or participant number]” for type Participant Actions, “silence on the call” for type General Actions, and “let's take a break” for Spoken Phrase.

When the user wants to be alerted when an event occurs, such as when the welcome page is presented in the collaboration, the user may select “welcome page” 508 by clicking on Select This Event button 510. Selecting button 510 moves the event to selected events list 512. Selected events list 512 comprises the events to which the user wants to be alerted. The user may also remove previously selected events by clicking on Remove button 514. Based on the content of selected events list 512 in this example, the user will be notified when the first question is asked, and when John Smith joins the collaboration.

FIG. 5B is an example of how a user may be prompted for additional information when selecting an event. Consider a user that wants to be notified when the user's manager joins the collaboration. The user may first select the Participant Actions type in Event Type list 502 in FIG. 5A. As previously mentioned, one of the events associated with the Participant Actions event type is the arrival of participants. When the user selects the desired event (“arrival”) in Event list 504, Define New Event dialog window 520 is presented to the user. The content of Define New Event dialog window 520 may change based on the event type selected in Event Type list 502. In this example, Define New Event dialog window 520 contains the event (“arrival of”) and prompts the user to provide additional information in drop down list of participants 522 by selecting the name of the participant upon whose arrival the user wants to be notified. Upon closing Define New Event dialog window 520, the user-defined event will be displayed in Selected Events list 512 in FIG. 5A.

Users may also define collaboration events themselves. For example, for each event type listed in pre-defined Event Type list 502, the user is also provided with the ability to define an event in Event list 504. By selecting “define new event” option in Event list 504, the user is allowed to define an event associated with an event type upon which the user wants to be notified. When the user selects “define new event” and clicks on Select This Event button 510, a dialog window, such as Define New Event dialog window 530 in FIG. 5C, may be presented to the user. In the dialog window, the user may select a type for the user-defined event. In this example, the user wants to be notified when a certain phrase is spoken during the collaboration. For instance, the user may want to be alerted when the user's name is mentioned, when the words “quiz”, “feedback” or using any other string of the user's choosing are spoken. For the event type, the user may select Spoken Phrase type in drop down list 532. The user may then enter a phrase in text box 534. Upon closing Define New Event dialog window 530, the user-defined event will be displayed in Selected Events list 512 in FIG. 5A.

Although the examples in FIGS. 5A-C show particular window display, event type, and event options, one of ordinary skill in the art would recognize that other window display, event type, and event options may be used to allow the user to select and define events for notification.

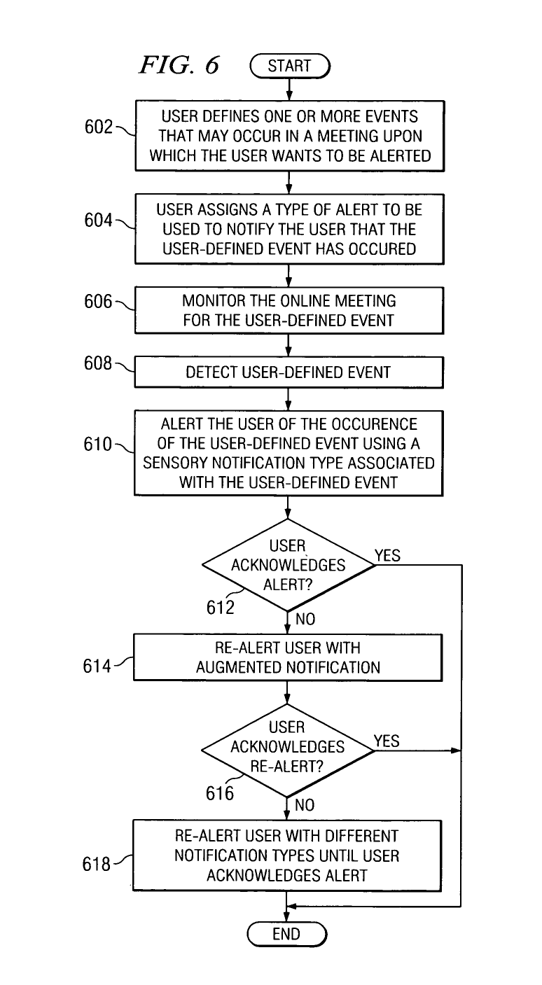

FIG. 6 is a flowchart of a process for improving interactive online collaboration using user-defined sensory notification or user-defined wakeups in accordance with an illustrative embodiment of the present invention. The process described in FIG. 6 may be implemented in a data processing system, such as data processing system 200 in FIG. 2.

The process begins with a participant of an online meeting defining one or more events that may occur in a meeting upon which the participant wants to be alerted (step 602). The participant may define the events prior to the start of the meeting, or, alternatively, the participant may define notification events while the meeting is in progress. By allowing a participant to define the events upon which to be alerted,-the participant may be re-directed to a specific point in the meeting upon which the participant should be paying attention. For example, if the online meeting is a presentation of various ongoing projects in a company, a participant who only works on “Project X” may not be interested in the other projects presented, but only wants to be alerted when content of the conference relates to “Project X”.

For each defined event, the participant may also assign a type of alert to be used to notify the participant that the user-defined event has occurred (step 604). The notification alert may comprise a sensory notification alert, wherein the participant is alerted through at least one of a visual, tactile, auditory, or olfactory manner.

Once events and notification types have been defined by the participant, the mechanism of the present invention monitors the meeting for the user-defined event (step 606). The mechanism of the present invention may monitor the meeting in various ways. For example, in a Webcast, the mechanism of the present invention may parse the audio and video feeds of the meeting using audio/video recognition software into electronic text. The mechanism of the present invention may then analyze the electronic text to determine whether an event defined by the participant has occurred in the meeting.

When an event defined by the participant is detected (step 608), the mechanism of the present invention alerts the participant by notifying the participant using the notification type associated with the user-defined event (step 610). A determination is then made as to whether the user has, in fact, been alerted to the event (step 612). This determination may be made by receiving a user acknowledgement that the alert has been received within a predefined period of time. For example, the user may be presented with a popup dialog box on the display. If the user clicks on the dialog box within the predefined time period, the user has been alerted to the event and is now focused on the meeting. The process is terminated thereafter.

If no acknowledgement is received from the user within the predefined time period, the mechanism of the present invention may re-alert the user that the event has occurred (step 614). This re-notification may include an augmented or increased notification, wherein the notification previously used to alert the user is amplified. For example, if an audio alert was previously used, the volume of the re-notification alert may be increased. Similarly, the scent in an olfactory alert may be made stronger, and the temperature used to provide a tactile alert may be increased or decreased from the initial alert.

If the user still has not responded to one or more augmented notifications (step 616), the mechanism of the present invention may alert the user using one or more different notification types or a combination of notification types (step 618) until the user acknowledges that the user is now paying attention to the content of the meeting.

Thus, aspects of the present invention provide a mechanism for improving interactive online collaboration using user-defined sensory notification or user-defined wakeups in online collaborative operating environments. With the mechanism of the present invention, each participant is allowed to define specific events in the online meeting, wherein the participant is alerted when a defined event occurs. By alerting the participant of the occurrence of a user-defined-event, the participant's focus is re-directed to a point in the meeting defined by the participant.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for alerting a user in a collaborative environment, the computer implemented method comprising:
receiving a user input from a user, wherein the user input defines an event in the collaborative environment to form a user-defined event;
monitoring the collaborative environment for an occurrence of the user-defined event; and
responsive to detecting the occurrence of the user-defined event, sending a sensory notification to the user to alert the user that the user-defined event has occurred.

2. The computer implemented method of claim 1, further comprising:
receiving another user input selecting the sensory notification from a set of sensory notifications and associating the user-defined event with the sensory notification.

3. The computer implemented method of claim 1, further comprising:
requesting that the user acknowledge receiving the sensory notification in response to sending the sensory notification to the user; and
responsive to an absence of a user acknowledgement, re-sending the sensory notification to the user.

4. The computer implemented method of claim 3, wherein the intensity of the sensory notification is increased each time the sensory notification is re-sent to the user.

5. The computer implemented method of claim 1, wherein the sensory notification comprises at least one of an auditory, visual, olfactory, or tactile alert.

6. The computer implemented method of claim 1, wherein the olfactory alert comprises emitting a scent.

7. The computer implemented method of claim 1, wherein the tactile alert comprises altering a temperature of one of a mouse or keyboard of the user.

8. The computer implemented method of claim 1, wherein the monitoring step comprises:
receiving at least one of an audio or video feed of the meeting;
parsing the audio or video feed;
creating an electronic text of the audio or video feed; and
analyzing the electronic text for the user-defined event.

9. The computer implemented method of claim 8, wherein the analyzing step identifies the user-defined event by detecting keywords corresponding to the user-defined event in the electronic text.

10. A data processing system for alerting a user in a collaborative environment, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to receive a user input from a user, wherein the user input defines an event in the collaborative environment to form a user-defined event, monitor the collaborative environment for an occurrence of the user-defined event, and send a sensory notification to the user to alert the user that the user-defined event has occurred in response to detecting the occurrence of the user-defined event.

11. The data processing system of claim 10, wherein the processing unit further executes computer usable code to receive another user input selecting the sensory notification from a set of sensory notifications and associate the user-defined event with the sensory notification.

12. The data processing system of claim 10, wherein the processing unit further executes computer usable code to request that the user acknowledge receiving the sensory notification in response to sending the sensory notification to the user, and re-send the sensory notification to the user in response to an absence of a user acknowledgement.

13. The data processing system of claim 12, wherein an intensity of the sensory notification is increased each time the sensory notification is re-sent to the user.

14. The data processing system of claim 10, wherein the sensory notification comprises at least one of an auditory, visual, olfactory, or tactile alert, wherein the olfactory alert comprises emitting a scent, and wherein the tactile alert comprises altering a temperature of one of a mouse or keyboard of the user.

15. The data processing system of claim 10, wherein the computer usable code to monitor the collaborative environment further comprises computer usable code to receive at least one of an audio or video feed of the meeting, parse the audio or video feed, create an electronic text of the audio or video feed, and analyze the electronic text for the user-defined event.

16. A computer program product for alerting a user in a collaborative environment, the computer program product comprising:
a computer usable medium having computer usable program code tangibly embodied thereon, the computer usable program code comprising:
computer usable program code for receiving a user input from a user, wherein the user input defines an event in the collaborative environment to form a user-defined event;
computer usable program code for monitoring the collaborative environment for an occurrence of the user-defined event; and
computer usable program code for sending a sensory notification to the user to alert the user that the user-defined event has occurred in response to detecting the occurrence of the user-defined event.

17. The computer program product of claim 16, further comprising:
computer usable program code for requesting that the user acknowledge receiving the sensory notification in response to sending the sensory notification to the user; and
computer usable program code for re-sending the sensory notification to the user in response to an absence of a user acknowledgement.

18. The computer program product of claim 17, wherein an intensity of the sensory notification is increased each time the sensory notification is re-sent to the user.

19. The computer program product of claim 16, wherein the sensory notification comprises at least one of an auditory, visual, olfactory, or tactile alert, wherein the olfactory alert comprises emitting a scent, and wherein the tactile alert comprises altering a temperature of one of a mouse or keyboard of the user.

20. The computer program product of claim 16, wherein computer usable program code for monitoring the collaborative environment further comprises:
computer usable program code for receiving at least one of an audio or video feed of the meeting;
computer usable program code for parsing the audio or video feed;
computer usable program code for creating an electronic text of the audio or video feed; and
computer usable program code for analyzing the electronic text for the user-defined event.
